(19) United States
(12) Patent Application Publication
(10) Pub. No.: US 2015/0066468 A1
(43) Pub. Date: Mar. 5, 2015

(54) DATA ACQUISITION SYSTEM AND A METHOD OF ACQUIRING DATA FROM A WIND TURBINE

(71) Applicant: Chris Damgaard, Herning (DK)

(72) Inventor: Chris Damgaard, Herning (DK)

(73) Assignee: KK Wind Solutions A/S, Ikast (DK)

(21) Appl. No.: 14/391,327

(22) PCT Filed: Apr. 16, 2012
(86) PCT No.: PCT/DK2012/000043

§ 371 Date: Oct. 8, 2014

(51) Int. Cl. F03D 11/00; G01M 15/14; G06F 17/50

(52) U.S. Cl. CPC F03D 11/0091; G06F 17/5009; G01M 15/14
USPC 703/18; 73/112.01

(57) ABSTRACT

The invention relates to a data acquisition system configured for acquiring operational data from one or more wind turbine components of a wind turbine, the data acquisition system comprising: a setup arrangement configured for establishing one or more data acquisition tasks, a user interface configured for allowing a user to access said setup arrangement, a wind turbine interface configured so that the setup arrangement can communicate with the wind turbine, wherein said user interface is configured for enabling the user to establish the one or more data acquisition tasks wherein the setup arrangement is configured for communicating one or more of the one or more data acquisition tasks to the wind turbine, and wherein said data set to be acquired is configured for being acquired from said data storage arrangement.

### FIELD OF THE INVENTION

The invention relates to a data acquisition system configured for acquiring operational data from one or more wind turbine components of a wind turbine, a method of acquiring operational data from one or more wind turbine components of a wind turbine, and a method of simulating one or more components of a wind turbine by means of a simulation environment.

### BACKGROUND OF THE INVENTION

During the years, the need and wish of collecting data from wind turbines has increased. However, as the number of available parameters in wind turbines also have increased significantly, the task of collecting relevant data from wind turbines has become a time consuming and complicated process.

EP 2 131 038 disclose a system and a method of for acquiring operational data from a wind turbine and analysing trip events. However, the solution in this document suffers for disadvantages in relation to e.g. collection of the data,

It is e.g. an object of the invention to provide an advantageous solution for collecting data from a wind turbine.

### BRIEF DESCRIPTION OF THE INVENTION

The invention relates to a data acquisition system configured for acquiring operational data from one or more wind turbine components of a wind turbine, the wind turbine comprising:
a plurality of sensors for performing wind turbine related measurements, and a data storage arrangement for storing of the wind turbine related measurements,

the data acquisition system comprising:
a setup arrangement configured for establishing one or more data acquisition tasks, the one or more data acquisition tasks comprising information of at least:
   operational data to be acquired from the data storage arrangement, and data collection criteria to be complied with before initiating acquisition of the operational data,
a user interface configured for allowing a user to access the setup arrangement,
a wind turbine interface configured so that the setup arrangement can communicate with the wind turbine, and
a data processor arrangement for handling data in the data acquisition system,

wherein the user interface is configured for enabling the user to establish the one or more data acquisition tasks based on:
a data set to be acquired, the data set being chosen from the operational data available in the data storage arrangement, and
at least one data collection criteria to be complied with before initiating acquisition of the data set,

wherein the setup arrangement is configured for communicating one or more of the one or more data acquisition tasks to the wind turbine, and

wherein the data set to be acquired is configured for being acquired from the data storage arrangement when the data collection criteria of the data acquisition tasks are complied with.

Being able to create user-defined data acquisition tasks is very advantageous. This is a way to receive information from a wind turbine relating to a scenario which is of interest e.g. when the wind turbine control software is to be optimized, if the root cause to periodic errors is to be found or remedied, if behavior of the wind turbine under given weather and/or production scenarios is to be monitored, etc.

Including one or more data collection criteria to the data acquisition task is very advantageous due to the fact that the user may even completely create the scenario in which information from the wind turbine is received. This may be done by specifying initiating parameters such as e.g. values, ranges and/or other scenarios related to the surroundings of the wind turbine such as e.g. wind speed, temperature, air humidity, time of the day, etc. which should be complied with to initiate collection of data.

Further it may be possible to specify initiating parameters relating to the wind turbine and its components. Such wind turbine components related initiating values/parameters may e.g. comprise pitch angle, blade deflection, yaw angle, rotor speed, shaft/generator speed/torque, start up or shut down commands from control software or any regulation actions made to the wind turbine or measurements including meteorological observations.

When having specified data collection criteria' such as e.g. determined the scenario in which information of the behavior of the wind turbine is desired it is very advantageous to be able to describe the wind turbine related information to be received. This may be done by defining a data set from operational data available in the data storage arrangement of the wind turbine.

Hence the present invention is very advantageous in that it allows a user to query specific data under specific conditions during operation of the wind turbine. This is very advantageous in that manual selection and/or identification of data in the data storage arrangement is avoided.

By the data acquisition system a very dynamic system is achieved since it may be possible to establish data collection requests that reflects user-defined scenarios. Such a user defined scenario may thus define user defined/selected criteria that has to be complied with and in relation to which operational data of one or more of the one or more wind turbine components is needed/wanted. Such a system may e.g. be especially advantageous in relation to identifying and solve e.g, non-optimal performance of a wind turbine and/or solving periodical faults registered in the wind turbine.

According to an embodiment of the invention the setup arrangement is configured for communicating the data set from the wind turbine via the wind turbine interface when the data set is acquired from said data storage arrangement to the user via the user interface.

This may e.g. be advantageous in relation to minimizing data communication. Also, a more dynamic system may be achieved.

In aspects, said acquired data set may be configured for being communicated from said wind turbine to said setup arrangement via the wind turbine interface when the data set has been acquired from said data storage arrangement.

According to an embodiment of the invention the one or more data acquisition tasks defines a period of time for which the operational data of the date set is to be acquired.

It may be advantageous to specify a period of time for which data is to be collected before and/or after the data collection criteria is complied with. This period of time may start when the data collection criteria is complied with and may run for a predefined number of seconds or minutes.

Alternatively and/or additionally this period of time may start a predefined number of seconds or minutes counting back from the time when the data collection criteria is complied with and continue to a predefined number of seconds or minutes after the data collection criteria is complied with.

According to an embodiment of the invention the one or more data acquisition tasks is defining a sample rate with which the operational data of the data set is to be sampled with.

It may be very advantageous to be able to determine the sample rate with which to operational data is to be sampled. This is because during normal operation of a wind turbine the sample rate is limited due to the capacity of the data storage arrangement. This limited sample rate may in some situations not be enough data to evaluate an error or irregularity observed in the wind turbine. Hence by increasing the sample rate the amount data is increased and thereby a higher resolution of data is obtained.

It should be mentioned that the sample rate may be adjusted according to the operational data to be acquired and what this operational data is to be used to afterwards i.e. the resolution of data is adjusted.

According to an embodiment of the invention said one or more data acquisitions task are stored in the data storage arrangement (11).

It is advantageous to place the data acquisition tasks in the data storage arrangement because then the data set which is gathered from operational data on the data storage arrangement by the data acquisition task does not need any additional use of the internal communication network after being stored on the data storage arrangement. This may e.g. minimise the risk of congestion on the internal communication network both when gathering the data set and when communicating the gathered data set to the setup arrangement or user which may wait until the internal communication network is ready for this communication.

According to an embodiment of the invention the one or more data acquisition tasks are created after installation of the wind turbine.

It is very advantageous to be able to create a data acquisition task after developing the software controlling and surveying the wind turbine. During development of this software it may not be possible to foresee all situations where it is important to get access to operational data from the wind turbine. Especially it is impossible to predict which operational data could help a technician remedy a periodic fault when the periodic fault may appear for the first time maybe months or even years after installation of the wind turbine.

By the term “After installation of the wind turbine” is to be understood the time where the wind turbine is installed on the site where it is intended produce energy, in other words either after the factory test, the commissioning or software deployment.

The factory test is defined as the final test of the different parts of the wind turbine before the wind turbine leaves the factory and thereby is ready to be installed and produce energy. Commissioning is defined as the tests before the owner of the wind turbine takes over responsibility of the wind turbine.

According to an embodiment of the invention the data acquisition tasks is configured for providing a notification to the setup arrangement (14) when the data acquisition task has acquired the operational data of the data set.

It is very advantageous for the setup arrangement only to receive a notification that data set is identified and ready to be retrieved because e.g. the setup arrangement may wait with downloading the data set until the internal communication network is not loaded with other data communication.

The setup arrangement may also forward the notification to the user which then may download the data set e.g. via a simulation tool.

According to an embodiment of the invention the data acquisition tasks is configured for providing the operational data of the data set to the setup arrangement (14) when the data set is acquired.

It may be advantageous for the setup arrangement to receive the data set as soon as it is gathered. This is for example true if the data set is to be used to in simulations for finding critical errors or root cause of irregular observations.

According to an embodiment of the invention the one or more data acquisition tasks is created by a user via a software application different from the setup arrangement (14).

It is very advantageous to be able to create a data acquisition task during use of a software application such as e.g. a simulation tool for simulating the performance of the wind turbine. During simulation it might turn out to be relevant to investigate a wind turbine component in more details and based hereon, e.g. from the simulation tool, create a data acquisition task. The data acquisition task may then manually via the user interface be provided to the setup arrangement or provided to the setup arrangement directly from the simulation tool.

According to an embodiment of the invention the data collection criteria are configured for being chosen from wind turbine related measurements from one or more of the plurality of sensors (9).

It is very advantageous to be able to initiate collection of operational data based on wind turbine related measurements because often the user-defined scenario from which it is desired to obtain operational data occurs during specific metrological conditions or during specific load situations of wind turbine components. As an example could be mentioned irregularities observed related to the converter of the wind turbine when the temperature is above certain level at the same time as the humidity is above a given percentage, i.e. the temperature and humidity are in this scenario the data collection criteria.

Another example could be irregularities such as non-expected vibrations observed at the blades when the blades are pitched to a certain pitch angle, e.g. between 5 and 11 degrees, when the wind is above a given wind speed i.e. the pitch angle and wind speed are in this scenario the data collection criteria.

It is in general to be understood that any relevant measurement from the wind turbine may be relevant as data collection criteria. Hence, at user may establish a dynamic and user specific/defined data collection request determined by means of e.g. a simulation.

According to an embodiment of the invention the data collection criteria comprises an internal software state variable.

It is very advantageous to be able to initiate collection of operational data based on execution of the control software controlling the wind turbine because often the user-defined scenario from which it is desired to obtain operational data may occur as a consequence of the control of a wind turbine component. As an example could be mentioned irregularities observed after a yaw motor has been activated. In this case the control software starting that yaw motor could trigger the collection of operational data related to such irregularities i.e. the internal state variable stating that yaw motor is being the data collection criteria.

According to an embodiment of the invention the wind turbine related measurements comprises measurements related to the environment in which the wind turbine is placed.

It may be very advantageous to be able to store information of the surroundings of the wind turbine on the data storage arrangement as part of the operational data. This is because then such environmental data may become part of a data set and thereby be part of post analysis of errors or irregularities observed at the wind turbine.

According to an embodiment of the invention the wind turbine related measurements comprises measurements relating to wind turbine components.

It is very advantageous to be able to store information related to wind turbine components on the data storage arrangement as part of the operational data. This is because in most cases an error or irregularity observed at a wind turbine origin from a wind turbine component and by including measurements from this wind turbine component in the data set it may be possible to find the root cause of the irregularity by analysis of the data set.

According to an embodiment of the invention the setup arrangement is configured for establishing and providing the one or more data acquisition tasks to the wind turbine at any time during the life of the wind turbine.

It is very advantageous to be able to create new data acquisition tasks when necessary during the entire lifetime of the wind turbine. This is because irregularities may occur at a random time during operation of the wind turbine.

In general, it is to be understood that a plurality of different unforeseen events may occur over the life time of a wind turbine after installation of the wind turbine. Such events may occur due to the individual grid that the wind turbine is connected to, it may occur due to the individual geographical area at which the wind turbine is located, it may occur due to the individual setup/configuration of the wind turbine, and/or the like. Thus it is advantageous to facilitate establishing and providing the data acquisition tasks during the life of the wind turbine to make it possible to analyze and solve problems occurred due to such unforeseen events.

According to an embodiment of the invention the setup arrangement is located on a wind power park server.

It is advantageous to locate the setup arrangement at the wind power park server in case the wind turbine from which data is to be acquired is part of a wind power park. Alternatively it is may be possible to locate the setup arrangement in another location either in relation to the wind turbine or remote to the wind turbine as long it is possible to establish a data communication between the wind turbine and the location of the setup arrangement. Such remote location could e.g. be at a server at the wind turbine service responsible people, at a server at the owner of the wind turbine, grid station, wind turbine manufacture, etc.

According to an embodiment of the invention said data acquisition system is configured for transmitting the acquired operational data to a simulation environment, said simulation environment being configured for simulating one or more components of said wind turbine.

This is advantageous in that the collected data may be of particular relevance in relation to simulations of components of the wind turbine. Due to the system facilitating a user to determine data collection criteria and data to be collected, the collected data may reflect relevant data to simulate in a simulation environment.

According to an embodiment of the invention said simulation environment is configured for utilizing said acquired operational data as input data for simulation of the wind turbine.

It is advantageous to be able to use the date set in a simulation environment having simulation models of the wind turbine/wind turbine components and of the environment. By simulating the actual control software running on the wind turbine with actual operational data obtained from the wind turbine and its surroundings the simulations of changes in the simulation models or control software is improved.

According to an embodiment of the invention said simulation environment is configured for utilizing the acquired operational data of the data set for verifying simulation models of the simulation environment.

It is advantageous to be able to use the data set in a simulation environment for verifying the models used in the environment. By using actual operational data from the wind turbine and its surroundings it is possible to eliminate uncertainties related to input to the models. Furthermore it is possible compare values from the simulation with the operational data from the wind turbine and thereby verify and/or optimise the simulation models.

According to an embodiment of the invention said simulation environment is configured for utilizing the acquired operational data of the data set for verifying the control software of the wind turbine via a simulation in the simulation environment.

It is advantageous to be able to use the data set in a simulation environment for verifying the control software running on the wind turbine. By using actual operational data from the wind turbine and its surroundings in simulations of the control software it is possible to adjust the control software and monitor the effect in the simulation environment. In this way it becomes possible to optimise the control software of the wind turbine.

According to an embodiment of the invention said simulation environment is configured for utilizing the acquired operational data of the data set for verifying the parameter settings of the control software of the wind turbine via a simulation in the simulation environment.

It is advantageous to be able to use the data set in a simulation environment for verifying the parameter settings of the control software running on the wind turbine. By using actual operational data from the wind turbine and its surroundings in simulations of the parameter settings of the control software it is possible to adjust parameter settings of the control software and monitor the effect in the simulation environment. In this way it becomes possible to optimise the parameter settings of the control software of the wind turbine.

According to an embodiment of the invention the acquired operational data of the data set is used for generating reports.

It is advantageous to be able to generate reports based on the data set from the wind turbine. This is because such reports may be generated automatically and because a data acquisition task may be designed to return just the data to be included in such a report.

Furthermore the invention relates to a method of acquiring operational data from one or more wind turbine components of a wind turbine, by means of a data acquisition system,
the wind turbine comprising a plurality of sensors for performing wind turbine related measurements, and a data storage arrangement for storing of the wind turbine related measurements,

said method comprising:

accessing a user interface so as to establish one or more data acquisition tasks based on:
a data set to be acquired, the data set being chosen from the operational data available in said data storage arrangement, and at least one data collection criteria to be complied with before initiating acquisition of said data set,

by means of a setup arrangement establishing a data acquisition task comprising information of at least:
operational data to be acquired from the data storage arrangement, and data collection criteria to be complied with before initiating acquisition of the operational data,

communicating said data acquisition task to the wind turbine, and

acquiring said operational data from said data storage arrangement when said data collection criteria of said data acquisition task is complied with.

According to an embodiment of the invention said operational data to be acquired is determined based on an output of a simulation environment.

When a wind turbine or a component of a wind turbine is simulated by means of the simulation environment, the result of the simulation may differ from the on-site result in/at the wind turbine that is simulated.

For example, a simulation of a component may give the result/output that the temperature of a simulated wind turbine generator during the simulated scenario would be in a predefined temperature range between D and E. It may hence be determined that measurement results may be relevant to retrieve from the simulated wind turbine to e.g. facilitate verifying the simulation result. Such relevant measurements may in the present example e.g. relate to wind speed and/or direction, ambient temperature in the nacelle and/or outside the nacelle, yaw data, load and/or vibration measurement results from the generator, blade pitch information etc. Hence, a data collection request comprising a data set to be acquired from the data storage arrangement may be determined from the simulation result. E.g. the data to be collected may comprise e.g. the temperature of the generator.

Also, it is understood that operational data to be acquired may be determined based on input to a simulation environment.

According to an embodiment of the invention said data collection criteria is determined based on an output of a simulation environment.

E.g. in the above mentioned example regarding verifying a simulation result, it may be relevant to determine data collection criteria based on an output from the simulation environment. For example, if a simulation result from simulating the generator temperature of the wind turbine estimates that by simulating the combination of A+B+C in the simulation model, it will result in a generator temperature in the range D to E, it may be relevant to collect A+B+C from the wind turbine when these parameters are in the range of the simulated scenario. For example, A may relate to a wind speed, B may relate to a pitch angle of the wind turbine blades and C may relate to the torque acting on the generator shaft. Hence, when the wind speed, the pitch angle and the generator torque gets within the simulated values and/or ranges, the generator temperature may be collected from the wind turbine to see if it lies within the range D-E. So in this example, the simulated parameters A, B and C with the simulated values of these parameters may be utilized as data collection criteria to verify the simulation. Naturally, the generator temperature(s) may also be collected when A, B and C are complied with.

A user may hence setup a data collection request with A, B and C as data collection criteria to be complied with before initiating acquisition of the operational data, and A. B and C and the resulting generator temperature may then be part of the data to be collected when A, B and C are complied with.

Alternatively, the simulation environment may in aspects be adapted for automatically identifying parameters in a wind turbine to be collected, and data collection criteria to be complied with and then automatically establish a data collection request.

According to an embodiment of the invention said acquired operational data is transmitted to a simulation environment, and wherein said acquired operational data is utilized for simulating one or more components of said wind turbine.

According to an embodiment of the invention said acquired operational data is used for verifying simulation models of the simulation environment.

Due to the dynamic capabilities of the data collection system, it may be possible to verify simulation models by establishing data collection requests e.g. based on the simulation of a wind turbine and on-site results from the simulated wind turbine.

According to an embodiment of the invention said acquired operational data is used for verifying the control software of the wind turbine via a simulation in the simulation environment.

According to an embodiment of the invention said acquired operational data is used for verifying the parameter settings of the control software of the wind turbine via a simulation in the simulation environment.

Furthermore the invention relates to a method of simulating one or more components of a wind turbine by means of a simulation environment, said method comprising:
acquiring operational data from a wind turbine by means of a data acquisition system according to any of claims 1-21 and/or by means of a method according to any of claims 22-27,
loading said acquired operational data into a simulation model for simulating one or more components of said wind turbine,
performing a simulation of said wind turbine by means of said simulation environment,
utilizing the result of said simulation for manipulating:
   control software of said wind turbine utilized for said simulation by means of said simulation environment,
   a model utilized for said simulation by means of said simulation environment, said model being a model of one or more of said one or more components of said wind turbine, and/or
   control software of said wind turbine

Furthermore the invention relates to a simulation environment configured for performing the method according to claim 29.

In general it is to be understood that any combinations of the above mentioned data acquisition system, the method of acquiring operational data and/or the method of simulating one or more components of a wind turbine by means of a simulation environment, and aspects thereof may be combined in any suitable way.

It is in general furthermore understood that the user interface may allow the user to enter user input by means of an input arrangement e.g. comprising a keyboard, a computer mouse, a touch screen and or the like. Furthermore, the user may access the user interface by means of a computer device such as e.g. a laptop, stationary computer, a smart-phone a tablet and/or the like.

Also, it is understood that the above mentioned simulation environment and/or data acquisition system may comprise any suitable number and/or configuration of computer processors, data storages, software applications, communication interfaces, and/or the like to facilitate achieving a data acquisition system and/or performing one or more method as disclosed in this document.

It is furthermore generally understood that the user may establish a data collection request by means of inputting user input. The user input may comprise selecting/entering the data set to be acquired, where the data is chosen from the operational data available in the data storage arrangement of the wind turbine, and data collection criteria to be complied with before initiating acquisition of the data set. Other user input may comprise a period of time for which the operational data of the date set is to be acquired, a sample rate with which the operational data of the data set is to be sampled with and/or the like.

Further, it is in general to be understood that in aspects, when a simulation of the wind turbine is mentioned may be understood one or more components of the wind turbine is simulated. Also, in aspects it may comprise combinations of one or more wind turbine components of the wind turbine. In further embodiments it may comprise a combination of (e.g. all) main components such as combinations of simulation models of e.g. a gearbox, a generator, and a converter.

### FIGURES

A few exemplary embodiments of the invention will be described in more detail in the following with reference to the figures, of which

FIG. 1 illustrates a wind turbine according to an embodiment of the invention,

FIG. 2 illustrates the data acquisition system according to an embodiment of the invention,

FIG. 3 illustrates a step diagram of use of an embodiment of the present invention, and

FIG. 4 illustrates a the use of a further embodiment of the invention.

### DETAILED DESCRIPTION OF THE INVENTION

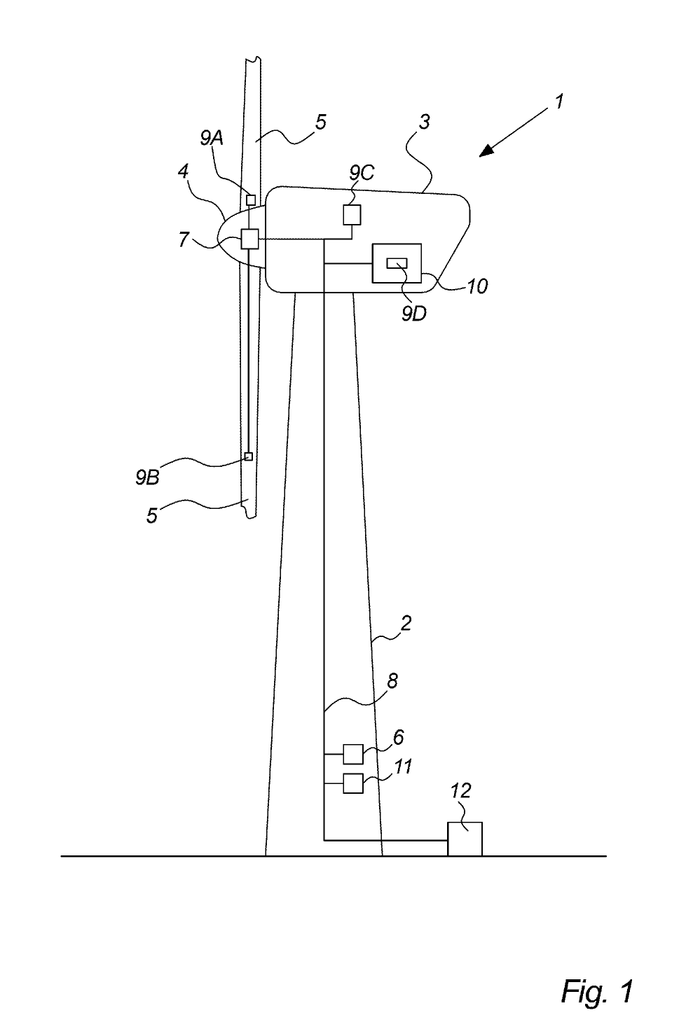

FIG. 1 illustrates an electrical power generating system in form of a wind turbine 1 according to an embodiment of the invention. The wind turbine 1 comprises a tower 2, a nacelle 3, a huh 4 and two or more blades 5. The blades 5 of the wind turbine 1 are rotatably mounted on the hub 4, together with which they are referred to as the rotor. The rotation of a blade 5 along its longitudinal axial is referred to as pitch.

The wind turbine 1 is controlled by a control system comprising control elements such as a wind turbine controller 6, sub controllers 7 for controlling different parts of the wind turbine 1 and one or more data storage arrangements 11 which the control system 6 uses as a central data storage for events data, operational data, data log, measurements, etc. At least some data may be stored continuously on the available data storage arrangements 11 even when the wind turbine 1 is not producing energy. The data storage arrangement 11 could be located on both the wind turbine controller 6, sub-controller 7 or a separate hardware.

Elements of the control system are communicating via communication lines 8. Communication lines 8 are also used for communicating with the data acquisition system 12 which preferably is located external to the wind turbine 1 e.g. at the developer of the control system.

Furthermore the wind turbine 1 comprises a plurality of sensors 9 of which only four is illustrated 9A-9D. The sensors 9 are measuring wind turbine related data as examples hereof could be mentioned that sensor 9A is for measuring blade root torque, sensor 9B is for measuring blade deflection, sensor 9C is for measuring wind speed and sensor 9D is for measuring generator speed of the generator 10. Hence the wind turbine related measurements refers to are measurements made inside or outside the wind turbine on temperature, humidity, rotor speed, wind speed, loads, etc.

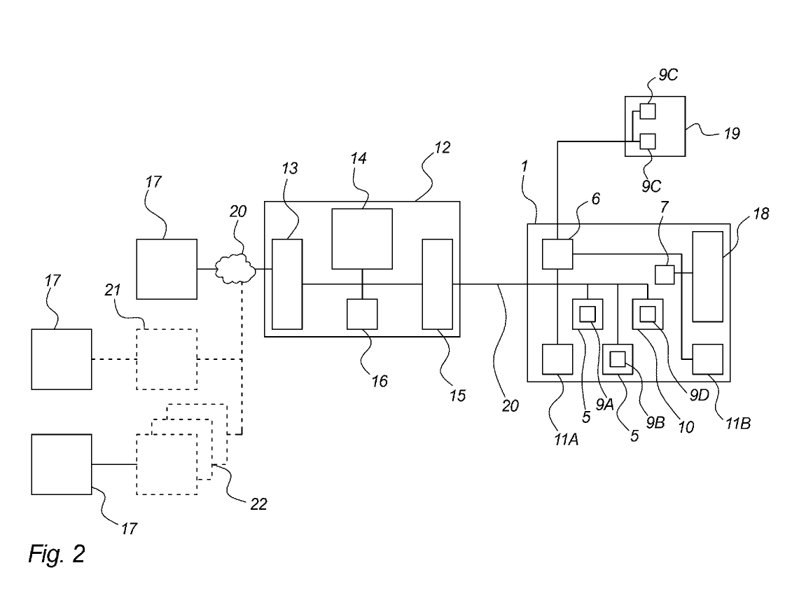

FIG. 2 illustrates the data acquisition system 12 according to an embodiment of the invention. The data acquisition system 12 comprises a user interface 13, a setup arrangement 14, a wind turbine interface 15 and a data processor arrangement 16.

The data processor arrangement 16 may e.g. facilitate processing of data need in communicating to and from the data acquisition system 12 and in the setup arrangement 14.

Furthermore FIG. 2 illustrates a user 17 communicating with the data acquisition system 12 via the user interface 13. From the dashed line it is indicated that the user 17 may communicate with the data acquisition system via a tool such as a simulation tool 21 as will be explained below.

Furthermore FIG. 2 illustrates a schematic view of the wind turbine 1 of FIG. 1. The wind turbine 1 comprises a wind turbine controller 6, sub controller 7 controlling a converter 18, data storage arrangements 11A, 11B, sensors 9A, 9B, 9C, 9D monitoring blades 5, generator 10 and metrological conditions from a weather station 19 located external to the wind turbine 1.

The sensors 9A-9D and additional not illustrated sensors are monitoring the respective wind turbine components and meteorological conditions and are communicating the measured data to one of the data storage arrangements 11A, 11B where it is stored and referred to as operational data or log data. The operational data is wind turbine related data which is relevant in the simulation, report 22 or analysis and which is measured or used in relation to control of the wind turbine 1.

It should be mentioned that the sensors 9 may be connected directly to the wind turbine controller 6 which e.g. could be the case with sensors for measuring operational data such as generator speed or wind speed. Alternatively sensors 9 may be connected directly to a data storage arrangement 11 such sensor could e.g. be a sensor for measuring blade root torque.

The data storage arrangement 11 could be located on/as part of a computer (also referred to as a personal computer or simply a PC) or standalone hard disk in the wind turbine, wind turbine controller 6 or in relation to sub-controllers 7 e.g. for controlling the converter, etc.

The elements of the wind turbine 1 are mutual connected by communication lines 8. It should be mentioned that any suitable data communication protocol could be used for exchanging of data between the elements of the wind turbine 1 of which some are illustrated in FIG. 2.

Communication between the wind turbine 1, user 17 and the data acquisition system 12 may use a public data communication network 20 depending on location of the data acquisition system 12.

The data acquisition system 12 is preferably located at a park server (not illustrated) in case the wind turbine 1 is part of a wind power park. Alternatively the data acquisition system 12 may be located on a computer or server at the service and maintenance responsible party, the wind turbine owner or any other appropriate location.

The invention as described in FIG. 2 may in one embodiment comprise a user 17 communicating with the setup arrangement 14, the setup arrangement 14 software being installed e.g. on the data storage arrangement 11 or as part of the wind turbine controller 6 of the wind turbine or a computer/server external to the wind turbine 1. From its location the setup arrangement 14 are communicating with the wind turbine 1 preferably with the data storage arrangement 11.

Even though above the data acquisition system 12 is described as being located on a park server or other locations external to the wind turbine 1 it should be mentioned that the data acquisition system 12 could also be located on the data storage arrangement 11, as part of the wind turbine controller 6 or any other appropriate location.

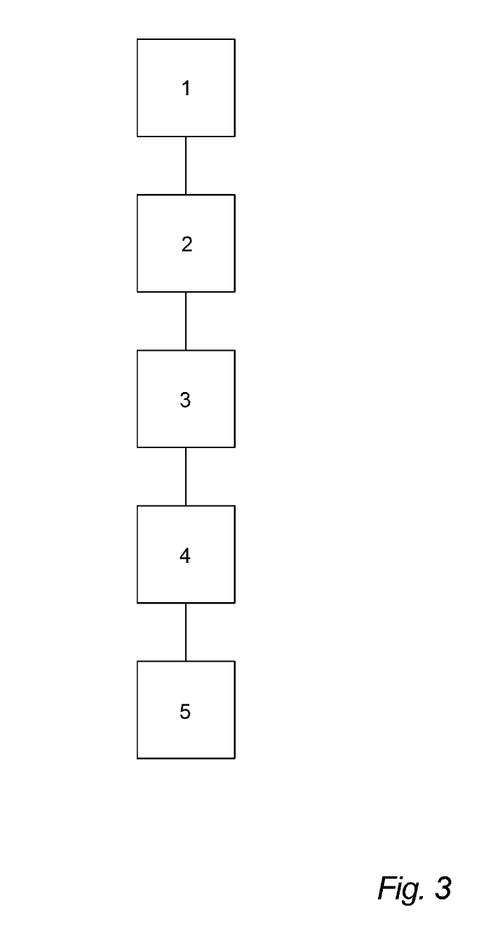

FIG. 3 illustrates a step diagram of use of the present invention according to an embodiment of the invention.

The use of the present invention is described according to the following scenario which is described with reference to FIG. 2. The sub controller 7 controlling the converter 18 is receiving measurements from a temperature sensor (not illustrated) that the temperature of a power stack of the converter 18 is rapidly increasing. The sub controller 7 are providing this information to the wind turbine controller 6 which determines to temporally shut down the hot power stack to avoid critical failure of that power stack. As a consequence the power production must be derated from e.g. 2 MW to 1,5 MW. Hence the wind turbine controller 6 or sub controller in form of power/speed controller is communicating to sub controllers of the pitch system to change the pitch angle to reduce production. When the temperature of the power stack again is normal the pitch system is asked to pitch the blades 5 to increase the power production to 2 MW.

All communication between controllers, converter and sensors and all measured values and variables related to the converter and meteorological information are stored on the data storage arrangement 11A at a sample rate defined by the data acquisition task as describe below. This means that during a user defined scenario the sample rate of operational data specified by the data acquisition task may be increased compared to the sample rate of the same operational data during normal operation. This gives the opportunity to obtain operational data in the exact resolution needed for the purpose of use (simulation, reports, etc.)

Step 1

The operator of the wind turbine is notified of the problem with the power stack temperature and contacts the person responsible of the service of the wind turbine.

Step 2

Since there has been no problem earlier with the power stack the service person are not going to manually search the logged operational date from this scenario or the default sample frequency of the measured and stored data is too low in order to exactly determine the root cause of the problem. Instead the service person create a data acquisition task where the data collection criteria describes the scenario in which the temperature of the power stack increased in order to automatically get operational data related to this scenario if the scenario should occur again in order to be able to determine what caused the increase of temperature of the power stack.

This data collection criteria(s) which triggers the collection of operational data could include surrounding temperature and wind speed, power production and temperature of the power stack. Furthermore data collection criteria could be an alarm, a trip event, rotor speed between a minimum and a maximum speed, etc. In the software, boolean operators can be used to create a logical expression that must be fulfilled.

The data acquisition task further comprises a data set describing which operational data should be collected. Here it could be relevant to collect information of temperature of the power stack and of the liquid of the cooling system of the converter three minutes before the data collection criteria's are complied with and three minutes after. Further it could be relevant to get information of temperature surrounding the converter 10, flow of liquid of the cooling system, etc.

A data acquisition task which is also referred to as a batch job comprising all the relevant operational data defining the data set to be retrieved as well as the data collection criteria initiating the collection of the data set is created by the user in the setup arrangement 14.

Beside the data collection criteria and the data set the batch job may also comprise information of the sample rate with which the data set is to be stored with, define for how long time the batch job should survey the data collection criteria, etc.

Step 3

The batch job is then uploaded to the wind turbine and located e.g. on the data storage arrangement 11 where it is monitoring variables defined by the data collection criteria.

Step 4

If or when the data collection criteria's are complied with the data set is collected and returned to the user. Alternatively the user is notified that the date set is completed and ready for download. The batch job may then be deleted or stay waiting for the next time the data collection criteria is complied with.

Step 5

The user receive the data set and is now ready to analyse the data set to find the root cause of the increase of temperature of the power stack.

It should be mentioned that the data acquisition task could be uploaded to the wind turbine 1, park server or other servers with access to the data storage arrangement 11 at the wind turbine 1.

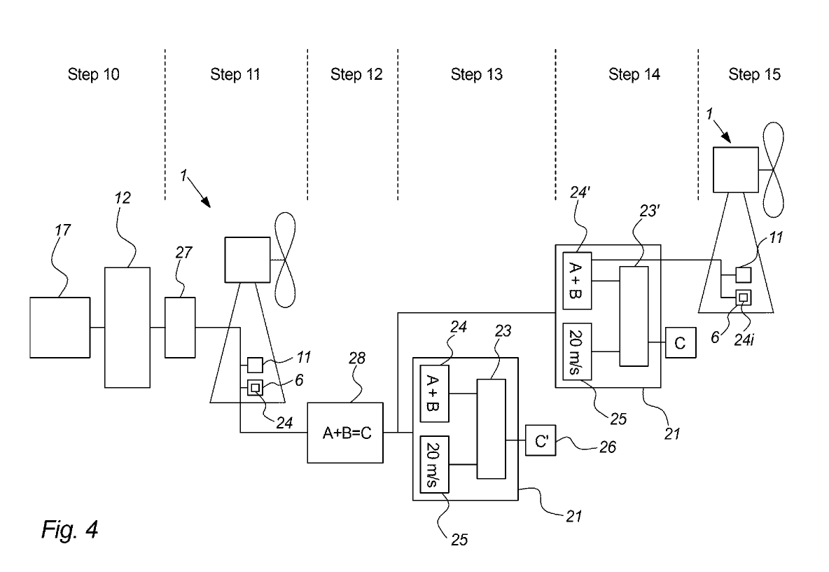

FIG. 4 illustrates the present invention according to a further embodiment of the invention where the data set returned from a data acquisition task is used to optimise the control software and/or to update a simulation model of the wind turbine.

A simulation model is created of the wind turbine 23 and the same control software 24 as is running on the wind turbine 1 is loaded to the wind turbine model. Further a model of the weather 25 acting on the wind turbine in the simulation environment 21 is created. From the simulation comes a simulation result 26.

Such simulation environment 21 may be used in case something is not running optimal at the real world wind turbine 1 in order to find the root cause of this none optimal performance.

According to this embodiment of the invention the data acquisition system 12 is used to automatically retrieve the operational data such as parameter settings from the wind turbine 1 in order to make the best possible match between the wind turbine 1 and the wind turbine model.

Step 10

A user creates a data acquisition task 27 by defining a scenario by selecting data collection criteria which is present in the case where the non-optimal performance is present. In this example the data collection criteria is when the wind speed is above 20 meter per second. Furthermore the user defines the data set which is to be collected when the data collection criteria is complied with. In this example the data set comprise control parameter A and B and parameter C which is the result of controlling the wind turbine according to parameter A and B and which cause the none optimal performance.

Step 11

The data collection task 27 is uploaded to the data storage arrangement 11 of the wind turbine 1.

Step 12

The data collection criteria are complied with i.e. the wind speed is above 20 meters per second. Parameters A, B and C are collected and comprised in the data set 28 within the period of time and with the sample rate defined by the data collection task i.e. by the user.

Step 13

The data set 28 is returned to the user or directly to a simulation environment 21 where the user can use the parameters A and B together with a wind speed above 20 meter per second in a simulation of the wind turbine. The result 26 of this simulation may be parameter C′. If C′ is different from the actual measured parameter C the model 23 of the wind turbine may be wrong or alternatively the control software 24 may need to be optimised or corrected.

Step 14

It is now possible to change the control software 24′ and/or the model of the wind turbine 23′ until C=C′ or until C′=C depending on which of the control software 24′ or wind turbine model 23′ is modified.

If the similarities of the model of the wind turbine 23′ and the real world wind turbine 1 is satisfying to the user, the user can start adjusting the control software 24 in order to get the desired result C i.e. eliminate the cause of the none optimal performance. This could be done by updating the control software 24 until C′ becomes equal to C or at least equal enough to satisfy the user. This may be achieved by analysing a specific part of the control software 24 and then try to modify different parameter settings (e.g. parameter A and B) of the control software 24. This may be continued until a result, an updated control software 24′, is achieved which when simulated outputs a result C′ which is actable to the user.

As mentioned the model 23 of the wind turbine 1 may also be modified based on the data set 28.

Step 15

The updated control software 24′ is then upload to the wind turbine 1 and the user can now wait until the next time the wind exceed 20 meters per second to see if the optimised control software 24′ has eliminated the none optimal performance as suggested by the simulation.

It should be mentioned that the data acquisition task may be created by the user via the simulation environment 21 and also returned to the user via the simulation environment 21.

According to a further not illustrated embodiment of the present invention the present invention could be used in relation to simulation of the wind turbine. First a wind turbine component to be simulated is chosen. Then a simulation model of the wind turbine component is chosen or created. The choice of simulation model also often determines the parameters need from the wind turbine. Then a data acquisition task is created defining the scenario in which these parameters are to be retrieved from the wind turbine 1. By scenario is also including sample rate also referred to as resolution of data and period of time. Then the data acquisition task is uploaded to an appropriate location at the wind turbine, park server, etc. When the data set is returned the data set is used in the simulation of the wind turbine component and the result of the simulation may be a suggestion to update of the control software or parameter setting in the control software, update of the simulation model, a report 22, etc.

As can be seen from the examples described in relation to FIGS. 3 and 4 the data acquisition task is eliminating time consuming manual work in that the user does not longer need to manual go through all data in the data storage arrangement 11 to find the right data set at the right time i.e. when data collection criteria's are complied with.

Further it becomes possible to define the sample rate with which the data set is to be stored which is extremely convenient. Due to the limited amount of space on the data collection arrangement compared to the large amount of logged operational data the standard sample rate is low as a consequence of the tradeoff between storing a huge amount of data and time this data should be kept.

If it is essential to obtain data at a high sample rate also before a data collection criteria is complied with the present invention may be implemented with a buffer arrangement such as a ring buffer or a first in first out buffer where data is stored with a high sample rate for a period of time and if not used the data is overwritten.

Furthermore it should be mentioned that the data acquisition task may also be tailored to return a desired data set describing operational data from a specific period of time and/or from a user-defined scenario which is queried e.g. from the owner of the wind turbine. The data set may be included into an automatically generated report 22.

The data acquisition task may be very easy to create. According to an embodiment of the invention the data collection criteria and the operational data could simply be chosen from a list of available variables. In the same way the desired sample rate could simply be selected from a drop down menu and the same goes for the period of time from in which operational data is queried. The lists and drop down menus may be accessible from the setup arrangement 14.

As mentioned there is different ways of returning the data set from the wind turbine when the data set is collected. When creating the data acquisition task it is possible to determine if the data set is to be sent back to the user 17 e.g. via the data acquisition system 12 when the data set is collected or if the user is to be notified for then later on to download the data set. Likewise it is possible to determine if the data set should be send to a simulation environment 21 or prepared for use in a report 22 or an analysis such as a Fourier Transformation to identify tower oscillations.

It should be mentioned that if the data set is large it may be possible to return the data set bit by bit and the transmission of data may even start before the desired data set is completely collected.

Because the data acquisition task is easy to create via the setup arrangement 14 the service personal which is physical at the wind turbine to maintain wind turbine components or the service personal which from a distance is able to update the control software can also do so.

This is advantageous because if a specific part of the control software has been updated it is possible to create a data acquisition task to check that the updated part of the software is working as expected in user-defined scenarios.

Further if a wind turbine component has been replaced it is possible for the service person to create a data acquisition task specific to check the performance of the new wind turbine component. As documentation for the performance it is possible to use the queried data set in form of an automatically generated report 22.

The user referred to in this document may be the developer of the control system controlling the wind turbine, the owner of the wind turbine, service persons or any other party for which access to the wind turbine is granted and the data to be collected may be relevant.

In general, it is to be understood that the invention is not limited to the particular examples described above but may be adapted in a multitude of varieties within the scope of the invention as specified in the claims. Furthermore, it is to be understood that two or more embodiments and/or features illustrated in one or more figures may also be combined in a multitude of varieties to achieve different embodiments not directly described in this document.

### LIST OF REFERENCE NUMBERS

1. Wind turbine

2. Tower

3. Nacelle

4. Hub

5. Blade

6. Wind turbine controller

7. Sub controller

8. Communication line

9. Sensors

10. Generator

11. Data storage arrangement

12. Data acquisition system

13. User interface

14. Setup arrangement

15. Wind turbine interface

16. Data processor arrangement

17. User

18. Converter

19. Weather station

20. Public data communication network

21. Simulation environment

22. Reports

What is claimed is:

1. A data acquisition system configured for acquiring operational data from one or more wind turbine components of a wind turbine,
the wind turbine comprising:
a plurality of sensors for performing wind turbine related measurements, and
a data storage arrangement for storing of the wind turbine related measurements,
the data acquisition system comprising:
a setup arrangement configured for establishing one or more data acquisition tasks, the one or more data acquisition tasks comprising information of at least:
operational data to be acquired from the data storage arrangement, and
data collection criteria to be complied with before initiating acquisition of the operational data,
a user interface configured for allowing a user to access the setup arrangement,
a wind turbine interface configured so that the setup arrangement can communicate with the wind turbine, and
a data processor arrangement for handling data in the data acquisition system,
wherein the user interface is configured for enabling the user to establish the one or more data acquisition tasks based on:
a data set to be acquired, the data set being chosen from the operational data available in the data storage arrangement, and
at least one data collection criteria to be complied with before initiating acquisition of the data set,
wherein the setup arrangement is configured for communicating one or more of the one or more data acquisition tasks to the wind turbine, and
wherein the data set to be acquired is configured for being acquired from the data storage arrangement when the data collection criteria of the data acquisition tasks is complied with.

2. A data acquisition system according to claim 1, wherein the setup arrangement is configured for communicating the data set from the wind turbine via the wind turbine interface when the data set is acquired from said data storage arrangement to the user via the user interface.

3. A data acquisition system according to claim 1, wherein the one or more data acquisition tasks defines a period of time for which the operational data of the data set is to be acquired.

4. A data acquisition system according to claim 1, wherein the one or more data acquisition tasks is defining a sample rate with which the operational data of the data set is to be sampled with.

5. A data acquisition system according to claim 1, wherein said one or more data acquisitions task is stored in the data storage arrangement.

6. A data acquisition system according to claim 1, wherein the one or more data acquisition tasks is created after installation of the wind turbine.

7. A data acquisition system according to claim 1, wherein the data acquisition tasks is are configured for providing a notification to the setup arrangement when the data acquisition task has acquired the operational data of the data set.

8. A data acquisition system according to claim 1, wherein the one or more data acquisition tasks is created by a user via a software application different from the setup arrangement.

9. A data acquisition system according to claim 1, wherein the data collection criteria is configured for being chosen from wind turbine related measurements from one or more of the plurality of sensors, and/or wherein the data collection criteria comprises an internal software state variable.

10. A data acquisition system according to claim 1, wherein the wind turbine related measurements comprise measurements relating to wind turbine components.

11. A data acquisition system according to claim 1, wherein the setup arrangement is configured for establishing and providing the one or more data acquisition tasks to the wind turbine at any time during the life of the wind turbine.

12. A data acquisition system according to claim 1, wherein said data acquisition system is configured for transmitting the acquired operational data to a simulation environment, said simulation environment being configured for simulating one or more components of said wind turbine.

13. A data acquisition system according to claim 12, wherein said simulation environment is configured for utilizing said acquired operational data as input data for simulation of the wind turbine.

14. A method of acquiring operational data from one or more wind turbine components of a wind turbine, by means of a data acquisition system,
the wind turbine comprising a plurality of sensors for performing wind turbine related measurements, and a data storage arrangement for storing of the wind turbine related measurements,
said method comprising:
accessing a user interface so as to establish one or more data acquisition tasks based on:
a data set to be acquired, the data set being chosen from the operational data available in said data storage arrangement, and
at least one data collection criteria to be complied with before initiating acquisition of said data set,
by means of a setup arrangement establishing a data acquisition task comprising information of at least:
operational data to be acquired from the data storage arrangement, and
data collection criteria to be complied with before initiating acquisition of the operational data,
communicating said data acquisition task to the wind turbine, and
acquiring said operational data from said data storage arrangement when said data collection criteria of said data acquisition task is complied with.

15. A method according to claim 14, wherein said operational data to be acquired is determined based on an output of a simulation environment.

16. A method according to claim 14, wherein said data collection criteria is determined based on an output of a simulation environment.

17. A method according to claim 14, wherein said acquired operational data is transmitted to a simulation environment, and wherein said acquired operational data is utilized for simulating one or more components of said wind turbine.

18. A method according to claim 14, wherein said acquired operational data is used for verifying simulation models of the simulation environment.

19. A method according to claim 14, wherein said acquired operational data is used for verifying the control software of the wind turbine via a simulation in the simulation environment and/or wherein said acquired operational data is used for verifying the parameter settings of the control software of the wind turbine via a simulation in the simulation environment.

20. A method of simulating one or more components of a wind turbine by means of a simulation environment, said method comprising:
acquiring operational data from a wind turbine by means of a data acquisition system according to claim 1,
loading said acquired operational data into a simulation model for simulating one or more components of said wind turbine,
performing a simulation of said wind turbine by means of said simulation environment,
utilizing the result of said simulation for manipulating:
control software of said wind turbine utilized for said simulation by means of said simulation environment,
a model utilized for said simulation by means of said simulation environment, said model being a model of one or more of said one or more components of said wind turbine, and/or
control software of said wind turbine.

21-30. (canceled)
